(19) United States
(12) Patent Application Publication
(10) Pub. No.: US 2023/0332730 A1
(43) Pub. Date: Oct. 19, 2023

(54) DISPLAY MOUNTS

(71) Applicant: Hewlett-Packard Development Company, L.P., Spring, TX (US)

(72) Inventors: Hung-Chang CHEN, Taipei City (TW); Hai-Lung HUNG, Taipei City (TW); Chih Jen HUANG, Taipei City (TW)

(21) Appl. No.: 17/720,053

(22) Filed: Apr. 13, 2022

(51) Int. Cl. F16M 11/04; F16M 11/10

(52) U.S. Cl. CPC F16M 11/046; F16M 11/10; F16M 2200/028

(57) ABSTRACT

According to an example, a display mount comprises a mount base to attach to a work surface, a body member having a first lateral side lateral to and wider than a second side, and a movable member to receive the body member. The movable member comprises a support element to attach to a display and a locking mechanism aligned with the second side of the body member and movable between an unlocked position in which the movable member is movable along a length of the body member and a locked position in which the locking mechanism fixes the movable member with respect to the body member.

### BACKGROUND

Display mounts are used to hold a part of an electronic device (such as a computing device or a display device) in a specific configuration with respect to a work surface. In use, a display mount has to withstand the load of an electronic device engaged which is engaged with a support element of the display mount.

### BRIEF DESCRIPTION OF DRAWINGS

Features of the present disclosure are illustrated by way of example and are not limited in the following figure(s), in which like numerals indicate like elements, in which:

FIG. 1 shows a detailed view of a display mount comprising a mount base, a body member, and a movable member, according to an example of the present disclosure;

FIG. 2A shows a detailed view of a body member and a movable member of a display mount, according to an example of the present disclosure;

FIG. 2B shows a detailed view of a body member and a movable member of a display mount, according to an example of the present disclosure;

FIG. 3 shows a detailed view of a display mount comprising a first pin element and a second pin element substantially parallel to the first pin element, according to an example of the present disclosure;

FIG. 4 shows a display device in multiple configurations with respect to a work surface, according to an example of the present disclosure;

FIG. 5 shows a computing system comprising a display, a mount base, an elongated body member, and a support member, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent, however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to.

Display mounts are used to hold electronic devices in specific configurations with respect to a work surface. Display mounts may be part of the electronic device, for example a display device including a display mount, or may be provided as a standalone device, for example a display mount to receive an external electronic device. By using display mounts, the position of the electronic devices (either as part of the device or as a standalone device) can be set in a secure, reliable, and stable manner.

However, the use of display mounts may reduce the effective area of the work surface. In particular, some display mounts may overlap with the work surface, thereby reducing the available space for a user. In addition, when using display mounts to hold electronic devices in specific configurations, the relative position of the electronic device with respect to the display mount may negatively impact the user when the electronic device is in use. For example, the use of the display mount may result in the electronic device being too close to the user. As a result, users may have to adapt their position with respect to the electronic device (for instance, moving farther away from the electronic device) to comply with ergonomic requirements (for instance, a relative position of the eyes of the user with respect to the electronic device).

As used herein, the term “work surface” will be used to refer to surfaces upon which display mounts may be placed, fixed, attached, screwed, or clamped. In some examples, the display mount may be attached to an edge of the work surface. In other examples, the display mount may be attached to a region of the work surface at a distance from the edge.

Disclosed herein are examples of display mounts, computing systems, and displays that mitigate the reduction of the effective area and the reduction of the space between the electronic device and the user of the electronic device.

Throughout this description, the term “electronic device” refers generally to electronic devices to be supported by auxiliary structures. Examples of electronic devices comprise displays, computer desktops, all-in-one computers, portable computers, amongst others.

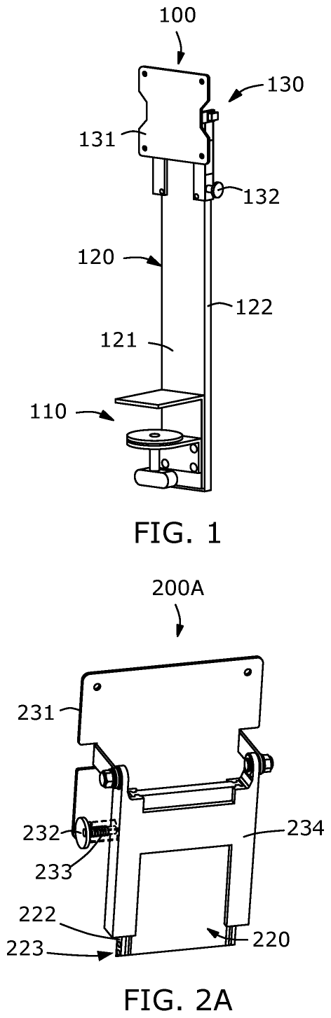

Referring now to FIG. 1, an example display mount 100 is shown. The display mount 100 comprises a mount base 110 to attach to a work surface (not shown in FIG. 1), a body member 120 having a first side 121 and a second side 122, and a movable member 130 to receive the first side 121 and the second side 122 of the movable member 130. The display mount 100 is to receive in the movable member 130 an electronic device such as a display (e.g., a display housing including a display screen). In particular, the movable member 130 comprises a support element 131 to attach to the electronic device (e.g., a display) and a locking mechanism 132 which may, in some examples, be aligned with the second side 122 of the body member 120 and movable between an unlocked position and a locked position.

In the unlocked position of the locking mechanism 132, the movable member 130 is movable along a length of the body member 120. As a result, a distance between the support element 131 and the mount base 110 of the display mount 100 is modified. On the other hand, in the locked position of the locking mechanism 132, the locking mechanism 132 fixes the movable member 130 with respect to the body member 120. Examples of locking mechanisms comprise a pin element to be received in one opening of a plurality of openings along the body member 120, a pair of pin elements to be received in multiple openings, a clamping element to brace a region of the body member 120 (such as the second side 122 of the body member 120), a threaded element to compress the second side 122 of the body member 120, a stopper element biased towards the second side 122 of the body member 120, among others.

In the display mount 100 of FIG. 1, the first side 121 of the body member 120 is lateral to and wider than the second side 122 of the body member 120. In other words, a medial surface defining a width of the body member 120 is wider than a lateral surface defining a thickness of the body member. In this fashion, a distance from the support element 131 to a back side of the body member 120 parallel to the first side 121 is reduced. In some examples, to further reduce an area of a projection of the support element 131 on the work surface, the body member 120 and the movable member 130 are arranged with respect to the mount base 110 such that support element 131 is aligned with an edge of the work surface. In an example, the body member 120 extends vertically from the back side of the mount base 110 to further reduce an area of a projection of the movable member 130 on the work surface. The above-mentioned examples enable both to mitigate a reduction of the effective area of the work surface because of the overlap of the display mount with the work surface and to keep the display mount (and its sub-components) as far as possible from the user.

Although in the display mount 100 of FIG. 1 the mount base 110 comprises a clamping member to attach the display mount to the work surface, alternative fixing elements may be used. In an example, the mount base 110 may comprise a fixing member to fix the mount base 110 with respect to the work surface by passing through an aperture of the work surface. In an example, the mount base 110 may comprise a screw clamp device to effectively attach the mount base to the work surface.

In some examples, the locking mechanism 132 of the movable member 130 may be in the form of a pin element and the body member 120 comprises a plurality of openings extending along the second side 122 of the body member 120. In particular, the pin element is to be removably inserted into one opening of the openings of the plurality of openings along the second side 122 in the locked position to fix the movable member 130 in place along the body member 120. On the other hand, in the unlocked position, the pin element is removed from the one opening of the plurality of openings such that the movable member 130 is movable along the body member 120.

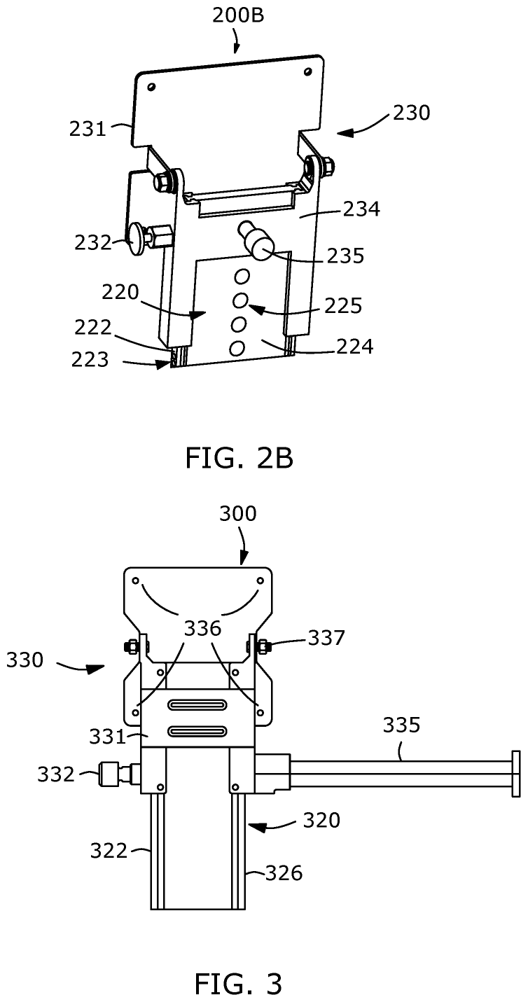

Referring now to FIG. 2A, a detailed view of a body member 220 and a movable member 230 of a display mount 200A is shown. The body member 220 of the display mount 200A comprises a second side 222 having a plurality of openings 223. The movable member 230 of the display mount 200A comprises a support member 231 to attach to an electronic device (e.g., a display), a locking mechanism in the form of a pin element 232 and a biasing member 233 engaged with the pin element 232, and a frame 234. In an example, the biasing member 233 may correspond with a linear spring. In other examples, the biasing member 233 may correspond with an element made of a material capable of recovering its shape after a force towards the element is released. In the display mount 200A, the biasing member 233 is to bias the pin element 232 towards the locked position in which the pin element 232 is removably inserted into one of a plurality of openings 223 extending along the second side 222 of the body member 220. On the other hand, upon the pin element 232 is pulled away from the frame 234, the pin element 232 moves to an unlocked position in which the movable member 230 is movable along the body member 220. By having available the pin element 232 on the second side 232, a user can move the pin element 232 between the locked position and the unlocked position without using additional tools for adjusting the position of the movable member 230 with respect to the body member 220.

In some examples, the pin element 232 of the display mount 200A may have a tip region with an angled surface. In this fashion, the pin element 232 is to move towards one opening of the plurality of openings 223 even if the pin element 232 is not perfectly aligned with respect to the aperture.

In the display mount 200A of FIG. 2A, the frame 234 is arranged to form an aperture in which the body member 220 is received. In addition, the frame 234 is arranged such that the aperture is defined by an inner profile of the frame 234. For instance, in FIG. 2A, the aperture is defined from a first rail to an opposing second rail of the frame 234. In order to match with the inner profile of the frame 234, the body member 220 comprises a corresponding profile to match with each of the first rail and the second rail such that the body member 220 is insertable into the frame 234 through the aperture. The use of rails in the inner surface of the frame 234 and corresponding profiles in the body member 220 mitigates the misalignment between the pin element 232 and the plurality of openings 223. Hence, even though there is a gap between the frame 234 and the body member 220, such gap does not result in tilting of the frame 234 (and hence, tilting of the movable member 220) with respect to the body member 220.

Referring now to FIG. 2B, a detailed view of a body member 220 and a movable member 230 of a display mount 200B is shown. The locking mechanism of the movable member 220 is in the form of a first pin element 232 and a second pin element 235. The body member 220 of the display mount 200B comprises a first plurality of openings 223 along a second side 222 and a second plurality of openings 225 along a third side 224 of the body member 220. In FIG. 2B, the third side 224 of the body member 220 corresponds to a region of the body member 220 perpendicular to the second side 222 and parallel to the first side (not shown in FIG. 2B, first side 121 in the display mount 100 of FIG. 1) of the body member 220.

In the display mount 200B of FIG. 2B, the second pin element 235 is used as a safety feature. In particular, by having available the second pin element 235, if a user does not move the pin element 232 to the locked position, the second pin element 235 may still fix the movable member 230 with respect to the body member 220. In an example, to reduce the chances of not fixing the position of the movable member 230, the locking mechanism may further comprise at least a biasing element, wherein at least one of the first pin element 232 and the second pin element 235 is engaged with a biasing element such that the pin element(s) move back to the locked position upon release of a pulling force towards the unlocked position of the pin element(s). In an example, to enhance the user experience when moving the movable member 230 along the body member 220, the first pin element 232 may be engaged with a biasing element. Then, to adjust the position of the electronic device attached to the support element 231 with respect to the work surface, users have to move the second pin element 235 (which is not engaged with the biasing element) to the unlocked position and hold the first pin element 232 in the unlocked position with a first hand. Later, users may manually adjust the position of the electronic device by moving with a second hand the electronic device (and hence, the movable member 230). Upon adjusting the position, users release the first pin element 232 and the biasing element moves the first pin element 232 to the locked position. Finally, users move the second pin element 235 to the locked position.

Although in the display mount 200B of FIG. 2B the second plurality of openings 225 is along the third side 224 of the body member 220, in other examples the second plurality of openings 225 may be disposed along a different side. In an example, the second plurality of openings 225 may be distributed along a fourth side lateral to the third side 224 and parallel to the second side 222 (i.e., the fourth side is opposite to the second side 222). Accordingly, the second pin element 235 may be arranged in the frame 234 to correspond with the location of the openings. In some other examples, the body member 220 comprises a plurality of openings along a side of the body member, and the first pin element 232 and the second pin element 235 may be removably inserted into two different openings of the plurality of openings. As a result of arranging both pin elements next to each other, the user may actuate both pin elements by using a single hand. In addition, by having available the openings on a lateral side of the body member 220, the user can easily reach the pin element(s) although an external element is located adjacent to the display mount 200B.

Referring now to FIG. 3, a display mount 300 comprising a locking mechanism in the form of a first pin element 332 and a second pin element 335 substantially parallel to the first pin element 332 is shown. In use, the first pin element 332 is removably inserted into an opening of a first plurality of openings along a second side 322 of the body member 320. Similarly, the second pin element 335 is to be removably inserted into an opening of a second plurality of openings along a fourth side 326 of the body member 320. In an example, the second pin element 335 is engaged with a biasing element. In other examples, the second pin element 335 may be locked and unlocked with respect to the body member by means of a locking element that locks the movable member 330 with respect to the body member 320 when the second pin element is at a specific angular position (for instance, an angle within a locking range defined from 90° to 270°) with respect to the body member 320. The availability of multiple pin elements at both lateral sides of the body member 320 provides enhanced safety levels. In addition, since both elements are substantially parallel, the user can easily adjust the position of the display mount. In addition, since the plurality of openings are disposed on opposing lateral sides, a back surface of the display mount 300 can be adjacent to another elements (such as a wall, adjacent display mount 300, or any other suitable surface).

In the display mount 300, the second pin element 335 has a length greater than a length of the first pin element 332 to enable a user to easily adapt the position of the movable member 330 with respect to the body member 320. In some examples, the available space for operating the first pin element 332 and the second pin element 335 may be limited. For example, the electronic device attached to the support element may span beyond the first pin element 332 and the second pin element 335, thereby reducing the available space for moving each of the first pin element 332 and the second pin element 335 to the locked position or the unlocked position. In an example, the second pin element 335 may be a telescopic pin element adjustable to a length within a range of lengths. In this fashion, users may enlarge or shrink the second pin element 335 such that the second pin element 335 does not extend from the electronic device but a modification of the electronic device position can be performed in a comfortable, secure, and effective way.

In FIG. 3, the support element of the movable member 330 comprises an attachment plate with a series of apertures 336 to attach the electronic device and a hinge element 337 to rotatably couple the attachment plate to the frame 331 of the movable member 330 such that an electronic device attached to the attachment plate is rotatable relative to the body member 330. In an example, the series of apertures 336 may be arranged in the attachment plate so as to comply with a VESA pattern standard.

According to an example, a mount base of a display mount is attached to a work surface to abut a first side (first side 121 in the display mount 100 of FIG. 1) of the body member against a lateral edge of the work surface. Hence, the arrangement of the body member with respect to the mount base does not result in a reduction of the effective area of the work surface.

According to other examples, a body member of a display mount may have a width within a range from 85 mm to 125 mm and the thickness is within a range from 6 mm to 12 mm. As a result, the body member effectively withstands loads of the electronic device attached to the movable member while not resulting in a reduction of the effective area of the work surface. In some examples, a display mount can support electronic devices having a weight of up to 10 kg.

According to some examples, a display device may include one of the display mounts 100, 200A, 200B, and 300 of FIGS. 1 to 3. In this fashion, a display screen of the display device can be effectively held at a vertical distance from a work surface without decreasing the effective area of the work surface.

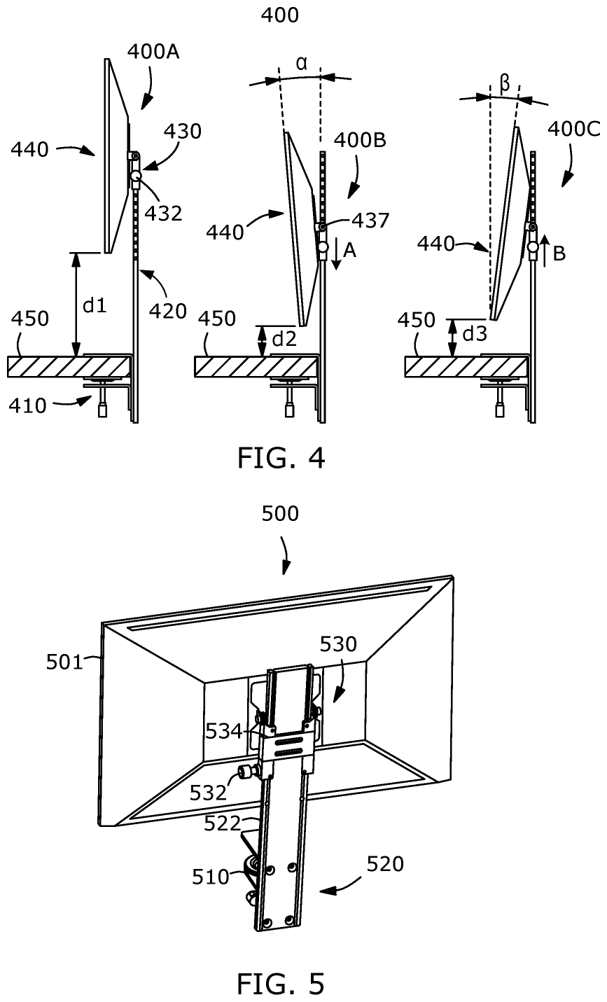

Referring now to FIG. 4, a display device 400 in multiple configurations with respect to a work surface 450 is shown. In particular, the display device 400 is represented in a first configuration 400A, a second configuration 400B, and a third configuration 400C. In each of the configurations 400A, 400B, and 400C, the display device 400 is clamped to the work surface 450 via a clamping member of a mount base 410. In other examples, the mount base 410 may have other suitable fixing element to fix the display device to the work surface.

In addition to the mount base 410, the display device 400 comprises a body member 420 having a length extending from an edge portion of the clamping member 410 in a direction perpendicular to a width and a thickness of the body member 420, a display screen 440 disposed within a display housing, and a movable member 430 coupled to the display housing and movable along the length of the body member 420. To reduce the decrease of the effective area of the work surface 450, the body member 420 has a width greater than a thickness. As previously explained, to set the movable member 430 at a position, the movable member 430 comprises a locking mechanism 432 to fix the movable member 430 with respect to the body member 420 such that the display screen 440 is fixed at a distance from the work surface 450.

In the first configuration 400A of the display device 400, a bottom region of the display screen 440 of the display device 400 is at a first distance d1 with respect to the work surface 450. In addition, the screen is parallel to the width of the body member 420, thereby being perpendicular to the clamping member 410 and the work surface 450.

In the second configuration 400B of the display device 400, the locking mechanism 432 has been unlocked, and the movable member 430 has been moved downwards in a direction A such that the bottom region of the display screen 440 is at a second distance d2 with respect to the work surface 450. Then, to fix the position of the screen with respect to the work surface 450, the locking mechanism has been moved to the locked position. In addition, the display screen 440 of the display device 400 has been tilted at an angle α with respect to the body member 420. To enable the rotation of the display screen 440 with respect to the movable member 430, the movable member 430 comprises a hinge element 437. In some examples, the movable member 430 may further comprise a swivel hinge to enable the rotation of the display screen 440 about a direction normal to the display screen 440. In some other examples the movable element 430 may further comprise a second hinge element to enable the rotation of the support about a direction perpendicular to the work surface 450.

In the third configuration 400C of the display device 400, the display screen 440 of the display device 400 has been rotated with respect to the body member 420 such that the screen 440 is at an angle β. In addition, the movable member 430 has been moved upwards in a direction B such that the bottom region of the screen 440 is at a third distance d3 with respect to the work surface 450.

According to an example, the bottom region of the screen 440 of the display device 400 may be set at a distance with respect to the work surface 450 within a range from 4 cm to 10 cm. However, in other examples, the range may be from 2 cm to 20 cm. Also, the screen 440 of the display device 400 may be rotated with respect to the body member 420 within a range from −6° to 9°.

As previously explained, different types of locking mechanisms 432 may be used for fixing the position of the movable member 430 with respect to the body member 420. In FIG. 4, the body member 420 comprises a plurality of openings distributed along a first lateral surface defining the thickness of the body member 420. Accordingly, the locking mechanism 432 is in the form of a pin element for locking the position of the movable member 430. In particular, to lock the relative position of the movable member 430 with respect to the body member 420, the pin element is inserted into an opening of the plurality of opening extending along the first lateral surface.

In some other examples, the body member 420 of the display device 400 comprises a first plurality of openings distributed along a first lateral surface of the body member 420 and a second plurality of openings distributed along a second lateral surface of the body member 420 opposite the first lateral surface, and the locking mechanism 432 of the movable member 430 comprises a first pin element and a second pin element engaged with a biasing element that biases the second pin element towards an opening of the second plurality of openings. To lock the position of the movable member 430, at least one of the first pin element and the second pin element is to be inserted into an opening of the first plurality of openings and the second plurality of openings, respectively. On the other hand, the movable member 430 is movable along the body member 420 when the first pin element and the second pin element are away from the respective openings of the first plurality of openings and the second plurality of openings.

Referring now to FIG. 5, a computing system 500 is shown. The computing system 500 comprises a display 501, a mount base 510 having a clamping member to clamp to a work surface (not shown in FIG. 5), an elongated body member 520, and a movable member 530 movably coupled to the body member 520. The elongated body member 520 extends from the mount base 510, and comprises a plurality of openings disposed along a lateral surface 522 of the body member 520. The body member 520 further comprises a medial surface defining a width of the body member 520 and a lateral surface defining a thickness of the body member 520, the width being greater than the thickness. The movable member 530 comprises a frame 534, a locking mechanism in the form of a pin element 532 engaged with a biasing element, and a support element coupled to the display 501.

The frame 534 of the movable member 530 of FIG. 5 is arranged to form an aperture for receiving the body member 520 such that the body member 520 extends through the aperture. In addition, the frame 534 comprises a through opening for receiving the pin element 532, wherein the elongated body member 520 is to extend through the aperture with the lateral surface of the body member aligned with the through opening. The pin element 532 comprises a pin body arranged to pass through the through opening of the frame 534, and the biasing element is to bias the pin element towards the lateral surface of the body member 520.

In the computing system 500 of FIG. 5, the pin element 532 is movable between a locked position in which the pin body is received in one of the plurality of openings on the lateral surface of the body member 520 and an unlocked position in which the pin body is away from the body member. However, as explained above, alternative locking mechanisms may be used. In an example, a second pin element may be used, such as the second pin element 335 of the display mount 300 of FIG. 3.

In some examples, the pin element 532 may further comprise a pin head having a diameter greater than the through opening of the frame 534. In use, the pin head may be used a stopper for the pin element 532 For instance, in the lock position, the pin head of the pin element 532 contacts the frame 534. On the other hand, in the unlocked position, the pin head is away from the frame 534. To move the pin element 532 from the locked position to the unlocked position, a push force is to be applied to the pin element 532.

As previously explained, in some examples, the frame 534 of the movable member 530 may comprise an inner profile to reduce the misalignment of the movable member 530 with respect to the body member 520. In particular, the frame 534 may be arranged such that the aperture defined by the frame 534 is defined from a first rail to a second rail of the frame 534. In addition, the elongated body member 520 comprises a corresponding profile to match with each of the first rail and the second rail of the frame 534. In an example, the frame 534 comprises a first rail and an opposing second rail to define the aperture and the elongated body member 520 comprises a corresponding profile to match with each of the first rail and the second rail such that the body member 520 is insertable through the aperture.

In some other examples, the mount base 510 of the computing system 500 is to engage with the work surface such that the body member is aligned with an edge of the work surface. In this way, the effective area of the work surface is not reduced when using the computing system 500. In other examples, the support element of the movable member 530 is arranged with respect to the mount base 510 such that a projection of the support element on the mount base 510 does not extend away from the mount base 510. In this fashion, a distance between a user of the computing system with respect to the screen 501 of the computing system 500 is increased, thereby reducing the negative effects of having a screen partially extending over a work surface.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims (and their equivalents) in which all terms are meant in their broadest reasonable sense unless otherwise indicated.

1. A display mount comprising:
a mount base to attach to a work surface;
a body member having a first side and a second side, the first side lateral to and wider than the second side; and
a movable member to receive the first and second side of the body member, the movable member comprising:
a support element to attach to a display, and
a locking mechanism movable between an unlocked position in which the movable member is movable along a length of the body member and a locked position in which the locking mechanism fixes the movable member with respect to body member.

2. The display mount of claim 1, wherein the locking mechanism comprises a pin element, wherein the pin element is removably inserted into one opening of a plurality of openings extending along the second side of the body member in the locked position to fix the movable member in place along the body member and is removed from the one opening of the plurality of openings in the unlocked position such that the movable member is movable along the body member.

3. The display mount of claim 2, wherein the locking mechanism further comprises a biasing member engaged with the pin element to bias the pin element towards the locked position.

4. The display mount of claim 3, wherein the pin element comprises a tip region having an angled surface.

5. The display mount of claim 1, wherein the support element comprises:
an attachment plate with a series of apertures to attach to the display, and a hinge element to rotatably couple the attachment plate to a frame of the movable member such that the display is rotatable relative to the body member.

6. The display mount of claim 1, wherein the mount base is to attach to the work surface so as to abut the first side of the body member against a lateral edge of the work surface.

7. A computing system comprising:
a display;
a mount base to attach to a work surface;
an elongated body member extending from the base, the body member comprising a medial surface defining a width of the body member and a lateral surface defining a thickness of the body member, the width being greater than the thickness, and a plurality of openings disposed along the lateral surface of the body member; and
a movable member movably coupled to the body member, the movable member comprising:
a frame arranged to form an aperture and comprising a through opening, the elongated body member to extend through the aperture with the lateral surface aligned with the through opening;
a pin element comprising a pin body arranged to pass through the through opening of the frame,
a biasing element engaged with the pin element, wherein the biasing element is to bias the pin element towards the lateral surface of the body member; and
a support element coupled to the display,
wherein the pin element is movable between a locked position in which the pin body is received in one of the plurality of openings on the lateral surface of the body member and an unlocked position in which the pin body is away from the body member.

8. The computing device of claim 7, wherein the pin element further comprises a pin head having a diameter greater than the through opening, wherein in the locked position, the pin head of the pin element contacts the frame and in the unlocked position, the pin head is away from the frame.

9. The computing device of claim 7, wherein the frame comprises a first rail and an opposing second rail to define the aperture and the elongated body member comprises a corresponding profile to match with each of the first rail and the second rail such the body member is insertable into the frame through the aperture.

10. The computing device of claim 7, wherein the mount base is to engage with the work surface such that the body member is aligned with an edge of the work surface.

11. The computing device of claim 10, wherein the support element is arranged with respect to the mount base such that a projection of the support element on the mount base does not extend away from the mount base.

12. A display device comprising:
a display screen disposed within a display housing;
a mount base having a clamping member to clamp to a work surface;
a body member having a width greater than a thickness, the body member having a length extending from an edge portion of the clamping member in a direction perpendicular to the width and the thickness of the body member; and
a movable member coupled to the display housing and movable along the length of the body member, wherein the movable member comprises a locking mechanism to fix the movable member with respect to the body member such that a distance between the screen and the work surface is fixed.

13. The display device of claim 12, wherein the width is within a range from 85 mm to 125 mm and the thickness is within a range from 6 mm to 12 mm.

14. The display device of claim 12, wherein:
the body member comprises a first plurality of openings distributed along a first lateral surface defining the thickness,
the locking mechanism comprises a first pin element, and
the locking mechanism is to lock the relative position of the movable member with respect to the body member upon insertion of the first pin element into an opening of the first plurality of openings.

15. The display device of claim 14, wherein:
the body member further comprises a second plurality of openings distributed along a second lateral surface, opposite the first lateral surface,
the locking mechanism further comprises a second pin element engaged with a biasing element that biases the second pin element towards an opening of the second plurality of openings, and
the movable member is movable along the body member when the first pin element and the second pin element are away from the respective openings of the first plurality of openings and the second plurality of openings.
